(19) United States
(12) Patent Application Publication
(10) Pub. No.: US 2014/0358633 A1
(43) Pub. Date: Dec. 4, 2014

(54) DEMAND TRANSFERENCE FORECASTING SYSTEM

(71) Applicant: Oracle International Corporation, Redwoodshores, CA (US)

(72) Inventors: Su-Ming WU, Waltham, MA (US); Sandeep TIWARI, Cambridge, MA (US)

(21) Appl. No.: 13/906,824

(22) Filed: May 31, 2013

(51) Int. Cl. G06Q 30/02

(52) U.S. Cl. CPC G06Q 30/0202
USPC 705/7.31

(57) ABSTRACT

A demand transference forecast system receives for a category of merchandise de-promoted sales data for each of a plurality of stock keeping units (“SKUs”), similarities between each pair of SKUs in the category, and SKU-store ranging information. The system determines a sales indices of all SKUs in the category across the de-promoted sales data for the category. The system determines Total Assortment Effect (“TAE”) variable quantities for the SKUs across share intervals in the de-promoted sales data based on the sales indices and the similarities. The system then generates a single parameter based demand transference model based on the similarities, the sales indices, and ratios of the share intervals.

### FIELD

One embodiment is directed generally to a computer system, and in particular to a demand transference forecasting system.

### BACKGROUND INFORMATION

A standard task in the operations of almost all retailers is deciding what specific items each store should carry in a particular category. For example, a typical supermarket may have hundreds of categories, among which could a “yogurt” category. A category manager for the grocer must decide, for each store, which yogurt stock keeping units (“SKU”s) the store will carry. The category manager for the yogurt category periodically reviews the yogurt assortments at the stores of the grocer, and may both remove and add various yogurt SKUs to the assortments under review.

The goals of the category manager in adding and removing SKUs from the assortments can be many and varied, and will depend on the specific business objectives that the retailer has for each category that the retailer sells. However, regardless of the business objectives that a category manager has, to make reasonable changes to an assortment, the category manager usually needs to know the “demand transference” that will result from adding or removing SKUs from the assortment. These demand transference effects are a major consideration a manager would use in determining the additions and removals to perform.

### SUMMARY

One embodiment is a demand transference forecast system that receives for a category of merchandise de-promoted sales data for each of a plurality of stock keeping units (“SKUs”), similarities between each pair of SKUs in the category, and SKU-store ranging information. The system determines a sales indices of all SKUs in the category across the de-promoted sales data for the category. The system determines Total Assortment Effect (“TAE”) variable quantities for the SKUs across share intervals in the de-promoted sales data based on the sales indices and the similarities. The system then generates a single parameter based demand transference model based on the similarities, the sales indices, and ratios of the share intervals.

### BRIEF DESCRIPTION OF THE DRAWINGS

FIG. 1 is a block diagram of a computer system that can implement an embodiment of the present invention.

FIG. 2 is a flow diagram of the functionality of the demand transference forecast module of FIG. 1 when determining a demand transference forecast in accordance with one embodiment.

FIG. 3 illustrates a histogram chart for SKUs in the “Coffee” category.

FIG. 4 illustrates a histogram chart for SKUs in the “Chocolate” category.

FIG. 5 illustrates a chart for store “1080”, “Chocolate” category, in accordance with embodiments of the present invention.

FIG. 6 illustrates a chart for store “1407”, “Chocolate” category, in accordance with embodiments of the present invention.

FIG. 7 illustrates a chart for store “1594”, “Chocolate” category, in accordance with embodiments of the present invention.

### DETAILED DESCRIPTION

When retail store assortments change, by addition or deletion of items from the store, consumers may start or stop buying other items in the assortment in response to the changes. One embodiment provides a forecast of this consumer behavior, given proposed changes in the assortment.

Demand transference” as applied to a retail store generally involves two types of effects: those resulting from the removal of an SKU from an assortment, and those resulting from the addition of a SKU to the assortment. Removing a SKU from a store's assortment will usually mean that some fraction of the customers who were purchasing that SKU will choose to purchase a similar SKU from the same store. Thus, a portion of the demand for the removed SKU transfers to the SKUs remaining in the assortment at the store. For example, in the yogurt category, if the category manager were to remove from the assortment the strawberry flavor of a particular brand of yogurt, many (but likely not all) consumers who were purchasing the removed yogurt could decide to purchase the strawberry flavor of another brand as a replacement. The replacement yogurt are in their minds similar enough to the removed yogurt that they are willing to switch instead of walking away from the store with no strawberry yogurt at all. Thus, the demand for the removed SKU consists of two parts: demand that will transfer to the remaining SKUs in the assortment, and lost demand, representing loss of demand from those shoppers who cannot find a SKU in the assortment that is similar enough to the removed SKU.

Conversely, suppose the category manager introduces a new SKU into the category's assortment at a store. Some shoppers at the store will switch from the SKU that they were already buying in the category to the newly-introduced SKU. Further, some shoppers at the store who never before bought any SKU of the category may start buying the new SKU. The demand for the new SKU thus consists of two parts: transferred demand from already existing SKUs in the category, and incremental new demand (or just incremental demand) from shoppers who were not already purchasing a SKU in the category.

Knowledge of these demand transference effects may influence a category manager's assortment decisions in the following ways:

The category manager may decide to remove a particular SKU because its lost demand will be small, meaning most shoppers will decide to switch to another SKU in the assortment.

Given a possible set of SKUs to add to an assortment, the category manager may pick the one that will bring the most incremental demand to the category. The category manager may decide to avoid adding SKUs whose incremental demand is very small, reasoning that adding such a SKU will raise costs without bringing in much more revenue.

Of course, the category manager does not rely solely on such considerations for deciding what assortment changes to make. However, it is clear that knowing the demand transference effects would be quite helpful to the category manager. One embodiment is a system that forecasts the demand-transference effects when it is given a set of possible additions and removals for an assortment at a particular store. Embodiments allow the category manager to run “what-if” scenarios to understand the effects of additions and removals without having to actually add or remove SKUs and then wait to observe what consumers will do. Therefore, embodiments provide a forecast of the demand-transference effects, and help the category manager make assortment decisions based on the forecast.

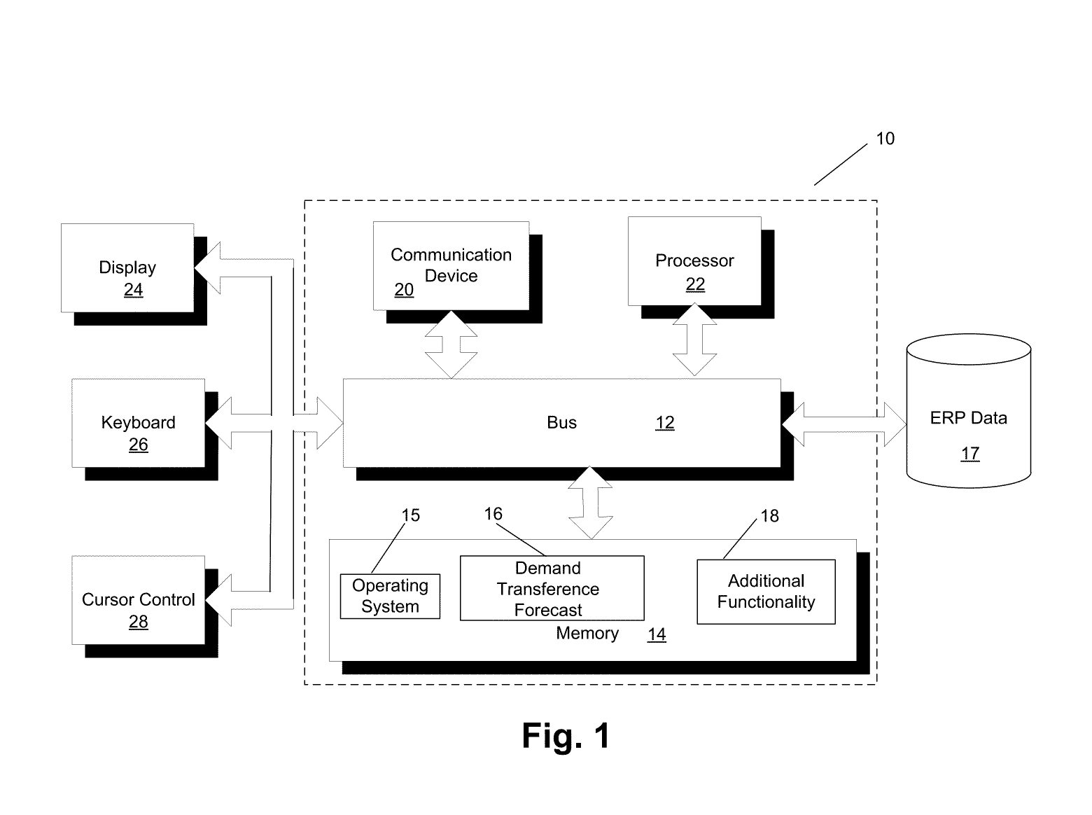

FIG. 1 is a block diagram of a computer system 10 that can implement an embodiment of the present invention. Although shown as a single system, the functionality of system 10 can be implemented as a distributed system. Further, all of the elements shown in FIG. 1 may not be included in some embodiments. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a demand transference forecast module 16 that forecasts demand transference as disclosed in more detail below. System 10 can be part of a larger system, such as “Retail Demand Forecasting” from Oracle Corp., which provides retail sales forecasting, or “Retail Markdown Optimization” from Oracle Corp., which determines pricing/promotion optimization for retail products, or part of an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing data and ERP data such as inventory information, etc.

Embodiments include statistical approaches for examining shopper behavior during assortment changes in historical sales data. For a particular category of merchandise, such as yogurt, embodiments examine total weekly sales-units shares for each SKU in the category at each store. Statistical techniques are used to detect changes in the shares that result from assortment changes, and a mathematical model is used to determine which changes in shares resulted from which assortment changes. Such a model is used because assortment changes for a typical retail store usually do not involve adding or removing only one SKU. Using this determination of the effects of each assortment change in history (referred to as the “demand transference parameters”, “demand transference estimation” or “demand transference model”), embodiments then forecast the effects of arbitrary, future assortment changes that the category manager is interested in performing.

### Demand Transference Parameters

In general, when determining demand transference parameters, embodiments treat each product independently so that each category receives its own set of parameters, and the calculation for a particular category is independent of any calculation for any other category. Thus, the term “assortment” is always relative to a particular category. For example, the “tea assortment” would mean the collection of teas carried at a particular store.

### Input Data Requirements

The following are the input data requirements, per category, in accordance with one embodiment:
1. De-promoted, segment-SKU-store-week sales units. This means sales-units series where the promotions have simply been leveled out (but with seasonality effects left in). Because promotional effects can greatly alter sales for one SKU while leaving other SKUs alone, they are not used as the inputs for demand transference estimation. If not using customer segments, then just SKU-store-week sales (treat all customers as being one big segment). Promotions that affect all SKUs in a category-store equally can be left in. Any effect that affects all SKUs in a category-store equally can be left in. In fact, if the promotions are few enough, then it is preferable to remove all weeks in a category-store where a promotion occurs, so there are no transference effects due to promotions.
2. SKU-to-SKU similarities at the segment-trading area level obtained using known methods, such as the similarity determinations disclosed in J. C. Gower and P. Legendre, “Metric and Euclidean Properties of Dissimilarity Coefficients” Journal of Classification, 3 (1986), pp. 5-48. In one embodiment, similarities are determined between two SKUs is by using “attribute similarity.” This approach produces a similarity value between 0 and 1 (with 1 meaning “completely similar”) as follows: suppose SKU A has attribute values a₁, a₂, . . . , aₙ, and SKU B has attribute values b₁, b₂, . . . , bₙ. Then simply take the number of attributes where aᵢ=bᵢ, that is, where the A and B have the same attribute values, and divide by n. The resulting fraction represents the fraction of attributes where A and B agree, and obviously this is between 0 and 1. For example, if A and B are two yogurts, and the yogurt attributes are Brand, Size, and Flavor, then the similarity between A and B is simply the number of attributes where A and B agree divided by 3. If A and B have the same brand, but differed in Size and Flavor, then the similarity would be ⅓. By considering these similarities as input, the demand transference estimation is broken out into its own separate module, where similarities can come from any source.
3. SKU-to-SKU similarities at segment-trading area level for “never-sold SKUs.” These are SKUs that the retailer has never sold before in any store. Since the retailer has no historical data for such SKUs, The similarities between such SKUs and all other SKUs (including other never-sold SKUs) can be determined as disclosed above.
4. SKU-store ranging information, meaning information about what intervals of time a particular SKU was sold in a particular store. This information is used to determine what assortment was being sold at a given store at any particular point in time. SKU-store ranging information is optional. If it is unavailable, then embodiments just use the earliest non-zero sale week as the start of when a SKU is present at a store, and the latest non-zero sale week as the end of when a SKU is present at a store. This presumes that the SKU was selling throughout all of the weeks in between.

### Sales Index Measurement

One embodiment models a measure of the “sales index” of a SKU relative to other SKUs in the category at a particular store. The “sales index” (referred to as the “index”) is a measure of the base sales rate of a SKU that is independent of seasonality, overall store sales rate, and assortment size. The index is an input to the demand transference model because SKUs that are high sellers can have a greater transference effect on other SKUs compared to low sellers, and the demand transference model should reflect such differences. Further, the measure of the size of a SKU should not be affected by seasonality, overall store sales rate, or assortment size.

The model measures the effect of SKUs on each other by using a variable called the “Total Assortment Effect” (“TAE”). The TAE captures the influence on an SKU of all other SKUs in the assortment. The variable TAE(i,s,w) for SKU i at store s in week w is calculated from data as follows:

TAE(i,s,w)=Σ_{jεa(s,w),j≠i}sim(i,j)·index(j,s,w) Equation 1

where the set a(s,w) is the set of items in the assortment of s at week w. Hence, the sum is taken over all items j different from i that are in the assortment of store s at week w. To determine the set a(s,w), SKU ranging information discussed above is used.

The quantity sim(i,j) is the similarity of item i to item j, and is provided as an input as disclosed above. The quantity index(j,s,w), called the SKU index, is a measure of the rate of sale of j at s relative to all other SKUs selling at s. It is designed to be independent of the size of the assortment of s.

The intent of index(j,s,w) is to be a store- and assortment-independent measure of the size of j relative to all other SKUs. Sales units alone cannot be used, because those would be dependent on the size of the store (supermarkets, for example, would sell more of a particular SKU then a convenience store), as well as seasonality. The sales need to be adjusted for the size of the store and for seasonality. The adjustment in one embodiment is as follows:
1. Calculate the sales-units share of j at s during week w (this adjusts for the size of the store and for seasonality, assuming that all items in a store have the same seasonality). Use the de-promoted sales units disclosed above as input data requirements.
2. Correct the shares for assortment count (disclosed below).
   Applying both corrections gives the desired store/assortment independence.

The share calculation is based on disjoint, contiguous intervals of 4 weeks each, rather than performing a share calculation specific to each week (this interval is referred to as the “share interval”). The problem with using weekly shares is that they tend to be quite volatile, because weekly sales are quite volatile (especially for low sellers). To avoid this volatility, 4-week intervals are used instead of 1-week intervals in one embodiment. The share calculation is the same as 1-week intervals, just extended to be over 4 weeks (thus w is over every 4^{th} week, not every week). For really low sellers, the volatility may still be so great that 4 weeks is not long enough. This is one reason to filter out such very low sellers.

In step 2 above, correction for assortment count is done by multiplying the share by the average assortment count at s over the 4-week interval, (Σ_{w}|a(s,w)|)/4, where the sum is taken over w in the 4-week interval. Without this correction, the SKU index would have a dependency on assortment count in that it would be larger or smaller solely because of how many items are in the assortment rather than reflecting the sales rate of the SKU itself.

The SKU indices tend to be around 1.0, showing that they are (mostly) independent of the store and of the assortment count. Specifically, if every SKU had the same sales rate, then all SKU indices would be 1.0. Further, if it is assumed that sales of all SKUs were constant, and if the assortment count decreased by the fraction k, and the share denominator also therefore decreased by approximately k, then index(j,s,w) would remain the same.

Without the correction for assortment count, it could be necessary to have a different assortment elasticity (disclosed below) for each assortment count. In particular, smaller stores typically have smaller assortments, and it would have been necessary to have different assortment elasticity for different stores. This is undesirable.

TAE for an SKU i accounts for both the similarity of other SKUs and also their “size”, or rate of sale. Similarity and rate of sale are the two factors through which other SKUs influence demand transference to or from i.

### Demand Transference Model

One embodiment determines the demand transference model based on the indices of the SKUs and similarities. The model is a “ratio model” in that instead of modeling sales units directly, it uses sales units shares instead. The use of sales shares allows the model to be a generally simpler, single-parameter model relative to prior art approaches. To model sales directly, it is possible that the model would need many other parameters to account for seasonality and overall store volume. Much greater computational effort would be required to determine values for these additional parameters. The parameter in the single-parameter model of embodiments of the invention is referred to as the “assortment elasticity. A standard single-variable linear regression can then be used to determine its value. It is also possible to perform this calculation with just correlation instead of linear regression, since in the one-variable case they are equivalent.

The demand transference model examines how the shares of SKUs change when the assortment changes, and models the changes as a power-law model in terms of TAE as follows:

Let D(i,s,w) be shares (the exact determination is described below as estimating assortment elasticity using linear regression). Then the model is:

$$\frac{D ( i , s , w )}{D ( i , {s}^{′} , {w}^{′} )} \sim {( \frac{1 + TAE ( i , s , w )}{1 + TAE ( i , {s}^{′} , {w}^{′} )} )}^{α} \qquad Equation 2$$

Where w and w′ represent two different time periods, or different weeks, and s and s′ represent two different stores. Thus, the ratio on the left-hand side represents changes in sales-unit shares for a particular SKU across time and across stores.

Now there is only a single parameter alpha (α) to estimate. Alpha is referred to as the “assortment elasticity”. This model says that share changes are due to assortment changes, and moreover that assortment changes cause share changes through changes in TAE. The assortment changes can be across time (thus there is both week w and week w′), and across stores (thus there is both store s and store s′).

The 1+ in the power law above is important because TAE(i,s,w) can be quite a small positive number, since the similarities can be quite small. Without adding 1, there would be a risk of using the wrong portion of the power-law curve (the portion that is asymptotic to the y-axis). Embodiments only use the portion of the curve where x≧1.

The exponent alpha should be negative for the model to make sense, meaning that removal of an SKU, which causes TAE to be smaller, should result in larger shares for the remaining SKUs in the assortment.

Having only one parameter to estimate is an advantage in comparison to prior art, because it means the regression can be formed within a database using Structured Query Language (“SQL”) in one embodiment. A single-variable regression can be coded in SQL, and thus the entire calculation can take place within the database.

In one embodiment, considered a “special case”, assume that s=s′, and that the assortment has not changed that much (e.g., fewer than 10% of SKUs) between w and w′. Suppose also that w and w′ are quite close together, so that seasonality differences are immaterial. Then the denominators in the shares D(i,s,w) and D(i,s′,w′) are relatively close, and thus the ratio of the shares is actually quite close to the ratio of sales (meaning the denominators can be eliminated). This allows the right-hand side of Equation 2 above to calculate changes in sales due to assortment changes, which indeed is the goal.

### Estimating Assortment Elasticity

As discussed above, one embodiment determines the value of the assortment elasticity using a single-variable linear regression. Initially, for a given store s, its “store-baseline” is constructed by dividing up its history into consecutive, disjoint 4-week intervals. For each such 4-week interval k, form the sum SB(k,s) of sales over the 4 weeks and over all items selling at the store during k. This is the same sales-units sum that is used in the denominator of the shares for index(j,s,w) for TAE of Equation 1 above.

Now for each item i at store s, produce the “shares series” D(i,s,k)=(Σ_{wεk}S(i,s,w))/SB(k,s). Dividing by SB allows the removal of seasonality from the regression, since the quotient no longer has seasonality in it (assuming seasonality is common across all items in a category-store). 4-week denominators are used in one embodiment in order to lessen volatility.

It is possible that the item i is only in the assortment for only m weeks out of the 4 weeks of k. In that case, scale up D(i,s,k) by multiplying it by 4/m. Note that a similar correction for the SKU indices used in TAE is not needed, because if the SKU index of a SKU is smaller due to the SKU spending less time in the assortment, then that is already correct—that SKU has cannibalized item i less because it was not in the assortment for the entire 4 weeks.

The ratios D(i,s,k)/D(i,s,k′) are now formed and are used on the left-hand side of the regression. In one embodiment, the ratios are formed only within the same store (thus the same s appears in both numerator and denominator). All pairs of 4-week intervals k and k′ are used to form these ratios.

On the left-hand-side of the regression, ((1+TAE(i,s,k))/(1+TAE(i,s,k′)), where TAE(i,s,k) is defined as TAE(i,s,w) where w is the first week of k. Since the definition of TAE involves the SKU index, which is already defined over all of k, the TAE from the first week of k already accounts for all of the weeks in k. α is now estimated through regular log-linear regression (in fact, a one-parameter regression).

### Model Apply

After the determination of the assortment elasticity, embodiments then use the assortment elasticity together with the demand transference model to forecast for the user the effects of additions to and removals from a given store assortment. The process of forecasting is referred to herein as “model apply”. Model apply in one embodiment is store specific, since assortments are store specific.

Model apply for demand transference uses the concept of the “current assortment.” Additions and removals of SKUs are with respect to this assortment. For the current assortment, model apply will give for each SKU in the assortment a factor by which the SKU's sales would have been raised (or lowered) due to the additions and removals. The “current assortment” in theory need not actually be currently selling; the choice of the “current assortment” depends on the exact application.

Multiplying these factors by the forecasted sales of each SKU in the current assortment then modifies the forecasts to give what each SKU will sell in the new assortment.

For example, suppose the “current assortment” at a particular store consists of the assortment that the store has been selling for the past two months. The retailer is interested in removing three particular SKUs in the current assortment, and wants to know what effect the removals will have. Model apply could give the effect of the removals in the following terms: it shows what the aggregate sales of each SKU in the assortment would have been during the past two months (aggregated over the two months) had the removed SKUs not been selling for the past two months. This provides the user with an easy way to understand the effect of the removals, since the same time periods are being compared. If instead, model apply gave the effect of the removals during the next two months, those effects might not be comparable to the last two months since any number of factors (such as seasonality) could come into play.

As another example, assume in the above situation, the retailer also wants a forecast for the next two months where the forecast accounts for the removals. Then it would be necessary to have a forecast for each SKU in the context of the current assortment, and then use model apply to multiply the forecasts by factors that adjust the forecasts up (or down). In general, model apply in accordance with embodiment of the invention can provide the factors to adjust the forecasts up or down.

### Model Apply Factors

In one embodiment, the model apply functionality has separate factors for removals and additions. Suppose R is the set of SKUs to be removed from the “current assortment”, and A is the set of SKUs to be added to the “current assortment”.

Removals: Removal of the SKUs in R causes some of the remaining SKUs to gain sales units, because a portion of the sales units of the SKUs in R transfers to the remaining ones.

The increase for each remaining SKU is determined in accordance with the “special case” disclosed above for Equation 2 where it is assumed that s=s′, and that the assortment has not changed that much (e.g., fewer than 10% of SKUs) between w and w′. For this special case, TAE(i,s) is calculated for two different assortments. The following removal fraction “RF” is the fraction by which a remaining SKU i increases after removal of the SKUs in R:

$$\begin{matrix}RF ( i , s ) = {( \frac{1 + TAE ( i , s ) + Δ TAE}{1 + TAE ( i , s )} )}^{α} \\ = {( 1 + \frac{Δ TAE}{1 + TAE ( i , s )} )}^{α} , Δ TAE < 0\end{matrix} \qquad Equation 3$$

The quantity ΔTAE is the amount by which TAE(i,s) changes due to the removals. Here, it is negative, because removing items reduces TAE(i,s). The terms in TAE(i,s) related to the SKUs in R drop out (see the formula for TAE).

Alpha should be negative, in which case RF comes out greater than 1, as it should for the remaining SKUs to gain in sales units. It is noted that TAE(i,s) is calculated in the context of the “current assortment,” and R and A represent changes to the “current assortment.”

Additions: handling additions considers two aspects:

The effect on existing SKUs of adding new SKUs. New SKUs will cannibalize existing SKUs.

Determining the sales rate of the new SKU at the store where it is added. Because the store has never sold this particular SKU, it will be necessary to perform some sort of forecast for the rate of sale of the new SKU at the store, where the forecast includes the demand transference effects of other SKUs in the assortment on the SKU.

The formula for TAE includes terms related to the added SKUs. Hence, for each SKU aεA being added to store s, the following are used: index(a,s) and sim(j,a) where SKU j can be either an existing SKU or an added SKU. In one embodiment, assume that sim(j,a) is given. The calculation of index(a,s) is disclosed below.

The following “addition fraction” is the fraction by which an existing SKU i decreases because of the additions A. The formula is the same as for RF, but ΔTAE is positive because TAE(i,s) is increasing due to the additions:

$$AF ( i , s ) = {( 1 + \frac{Δ TAE ( i , s )}{1 + TAE ( i , s )} )}^{α}$$

$$Δ TAE ( i , s ) = {\sum }_{a ∈ A}^{ } index ( a , s ) \cdot sim ( i , a )$$

Since alpha is negative, this quantity is less than 1 (likely slightly less than 1), representing the fraction of decrease of SKU i due to cannibalization from adding aεA.

### Demand Transference for New SKUs

As disclosed above in connection with the demand transference, the provision of a forecast F(a) for the sales for a new SKU aεA in the context of the current assortment is assumed and inputted. This forecast is then used in the calculation of index(a,s). A standard approach in the retail-software industry for determining F(a) is for the retailer to specify a so-called “like item” for a, meaning another SKU with a forecast whose sales behavior is thought to be very similar to a. For example, the “Retail Demand Forecasting” from Oracle Corp. uses a like-item approach.

For the calculation of index(a,s), F(a) should be the numerator in the sales-units share calculation. The denominator in the share calculation should be a sum over the SKUs in the current assortment plus the sum of F(a) over the SKUs in A. The assortment count should include the added SKUs. Thus, for example, if A consists of seven SKUs, then the denominator should include the addition of the forecasted sales of the seven added SKUs, and the assortment count should be increased by seven over the assortment count of the current assortment.

As disclosed, F(a) gives a forecast for SKU a in the current assortment, meaning assuming SKU a alone is added to the current assortment. The forecast F(a) accounts only for the effect on SKU a of the SKUs in the current assortment, not the effect of all the other SKUs in A. For an SKU aεA, account for the effect of the SKUs in A−{a} by using the same formula for AF disclosed above, but with:

$$Δ TAE ( a , s ) = {\sum }_{b ∈ A - a}^{ } sim ( b , a ) \cdot index ( b , s )$$

F(a) is then multiplied by AF(a,s) to finally get the forecast of SKU a that accounts for adding all SKUs in A.

### Applying the Addition Factors and Removal Factors in a “What-if” System

The term “sales” refers to de-promoted, segment-SKU-store-week sales covering the very recent past for each SKU that is in the current assortment. The “what-if” system described above shows how these sales would have been changed due to changes in the assortment. The “what-if” system uses aggregates of these de-promoted sales for model apply. For example, two-month aggregates can be used, meaning for each SKU, aggregate its de-promoted sales over the most recent two months. Model apply in accordance with one embodiment will then determine how these aggregated sales would have changed for each SKU had the assortment been different. Let AGG(i,s) be these aggregates for a SKU i at store s.

Model apply for “what-if” runs in two phases, in this order in one embodiment:

Removal of existing SKUs. As discussed, the set R of SKUs is the set of SKUs to remove.

Addition of new SKUs. As discussed, the set A of SKUs is the set of SKUs to add.

Model apply ultimately produces factors for the existing SKUs in the assortment (except for the ones in R), and a forecast for the ones in A.

In the first phase, the removal factors RF are applied to obtain the increases in each SKU i resulting from the removals:

AGG1(i,s)=AGG(i,s)·RF(i,s)

Note that the “total category loss” from removal of R consists of: loss due to removal of the SKUs in R minus increases due to the above calculated transference. The increases due to transference offset the losses due to removals.

For phase 1, the following “guard rail” is also applied: the sum of the increases due to transference must not be larger than the total sales of all of the removals. Without this guard rail, it is possible that the total category volume would increase as a result of the removals, which does not make intuitive sense.

In experimental tests, it was found that the guard rail was only necessary a few percent of the time. The test consisted of deleting every single SKU one at a time and calculating demand transference effects for each removal. The guard rail was needed for only a few percent of the SKUs.

For phase 2, the addition phase, the addition factors AF are applied on top of RF:

AGG2(i,s)=AGG1(i,s)·AF(i,s)

AGG2 is now the final result for “existing” SKUs of the removals and additions.

During phase 2, in one embodiment it is also necessary to provide the new-SKU forecasts. It may also be necessary to apply a second guard rail, namely: the sum of the decreases of each AGG1 to form AGG2 should not be greater than the sum of the new-SKU forecasts (otherwise the category volume will decrease due to the additions).

### Restricting the Magnitude of Assortment Elasticities

One embodiment implements a rigorous method of determining the correct range for assortment elasticity. Frequently, in mathematical models of this type, where the parameters of the model are determined from historical sales data, it is entirely possible to obtain values for the parameters that are not within a reasonable range, due to outliers in the historical data or insufficient historical data. Usually, it is not possible to rigorously identify when a parameter has an unreasonable value. However, one embodiment identifies a correct range for assortment elasticity.

If assortment elasticity has too large a magnitude, then it is possible for removal of a SKU from the current assortment to result in “higher” total sales from the remaining SKUs. A large magnitude of assortment elasticity will cause too much transference to the remaining SKUs, so much transference that the remaining SKUs will receive more sales units than the removed SKU actually sold, thus resulting in an overall category increase. This is typically a nonsensical result, since removal of items from an assortment should cause a decrease, not an increase.

Consider the following constraint:

For each store, removal of any single SKU from the current assortment shall not increase the category volume at the store (the category volume is the sum of the sales of the remaining SKUs).

Based on this constraint, it is possible to derive an upper bound on the magnitude of Assortment Elasticity using the formulas for model apply.

Using the notation previous disclosed above (i.e., let AGG(i,s) be these aggregates for a SKU i at store s), suppose j is the SKU that is being removed, and s is a particular store. Then the above constraint is:

$${\sum }_{i}^{ } AGG ( i , s ) = AGG ( j , s ) + {\sum }_{i \neq j}^{ } AGG ( i , s ) \geq {\sum }_{i \neq j}^{ } AGG 1 ( i , s )$$

This can be translated into a constraint on alpha, using the RF notation disclosed above:

$$AGG ( j , s ) \geq {\sum }_{i \neq j}^{ } ( AGG 1 ( i , s ) - AGG ( i , s ) ) = {\sum }_{i \neq j}^{ } ( AGG ( i , s ) \cdot RF ( i , s ) - AGG ( i , s ) ) = {\sum }_{i \neq j}^{ } ( AGG ( i , s ) {( 1 + \frac{Δ TAE ( i , j )}{1 + TAE ( i , s )} )}^{α} - AGG ( i , s ) ) \geq {\sum }_{i \neq j}^{ } ( AGG ( i , s ) ( 1 + α \frac{Δ TAE ( i , j )}{1 + TAE ( i , s )} ) - AGG ( i , s ) ) = α {\sum }_{i \neq j}^{ } AGG ( i , s ) \frac{Δ TAE ( i , j )}{1 + TAE ( i , s )}$$

The second to last step uses the linear approximation y=1+αx of y=(1+x)^{α}around x=0. This approximation is a lower bound where xε[0,1) and thus the right-hand side is an “underestimate” of the amount of transference (hence the inequality).

Continuing from above, the following is obtained:

$$\frac{AGG ( j , s )}{{\sum }_{i \neq j}^{ } AGG ( i , s ) \frac{Δ TAE ( i , j )}{TAE ( i , s )}} \leq α \qquad Equation 4$$

The quantity on the left hand side in fact will be negative because the ΔTAE are negative, and thus the inequality states that alpha must be greater than a certain negative quantity.

Because the transference is underestimated, the above bound on alpha may be too weak (meaning the bound should be larger). More negative alphas give larger transference, and thus it may be necessary to use an alpha that is less negative than the above bound indicates. Hence, the bound is a necessary but not sufficient condition.

When this bound is actually used in an application, the application should still calculate the transference that results using the above bound as the alpha value without using an approximation in order to determine whether a higher bound is necessary.

While the approximation is always a lower bound on [0, 1), the approximation is less accurate in case where x is close to 1 or alpha is very negative. (The case where x is close to 1 would occur when ΔTAE/(1+TAE(i,s)) is close to 1, which would only occur for stores that have quite small assortments, such as under 5 items.)

Further, this lower bound on alpha is based only on removal of single items. It does not consider multiple-item removal. In this respect as well, the bound is only a necessary rather than sufficient condition.

One embodiment further allows the user to control the amount of transference that the model will forecast. Embodiments provide a simple way for the user to control the amount of transference that occurs, so that if the user has a strong opinion, based on experience, of the amount of transference, the user can implement that opinion. It is also possible to use a better approximation, and thus accommodate stores with small assortments. The following small enhancement of the above allows the user to directly specify a limit on the amount of transference.

Suppose the user requires that no SKU j transfer more than the fraction M of its demand to the remaining SKUs. Expressing this is simply a matter of adding M to the above inequalities:

$$M \cdot AGG ( j , s ) \geq {\sum }_{i \neq j}^{ } ( AGG 1 ( i , s ) - AGG ( i , s ) )$$

The bound on alpha then becomes:

$$\frac{M \cdot AGG ( j , s )}{{\sum }_{i \neq j}^{ } AGG ( i , s ) \frac{Δ TAE ( i , j )}{1 + TAE ( i , s )}} \leq α \qquad Equation 5$$

The smaller M is, the less negative the bound on alpha is. The formula for the above bounds are for a particular store s, so it is possible that each different store produces a different bound for alpha.

### Generating a Linear Demand Transference Model

One embodiment transforms the demand transference model into a linear model so that the forecasts it produces can be used within optimization methods, such as linear programming, that require linear constraints and functions.

For performing the removals in one embodiment linear approximation is used. For the RF factor of equation 3 above, the function y=(1+x)^{a} is approximated around x=0 by the linear approximation y=1+ax. With this linear approximation, note that RF−1 is now linear in ΔTAE. Using this linear approximation allows writing a linear program for performing optimization where the objective function accounts for demand transference.

In terms of matrices:

\vec{RF}(s)=1+αA(s)\vec{x}

Each row is a SKU of store s, and the vectors RF and x are column vectors, with length equal to the number of SKUs at store s. The matrix A(s) is

$${A ( s )}_{i , j} = \frac{sim ( i , j ) \cdot index ( j , s )}{1 + TAE ( i , s )}$$

The vector x is −1 for SKUs that are being deleted, and 0 otherwise.

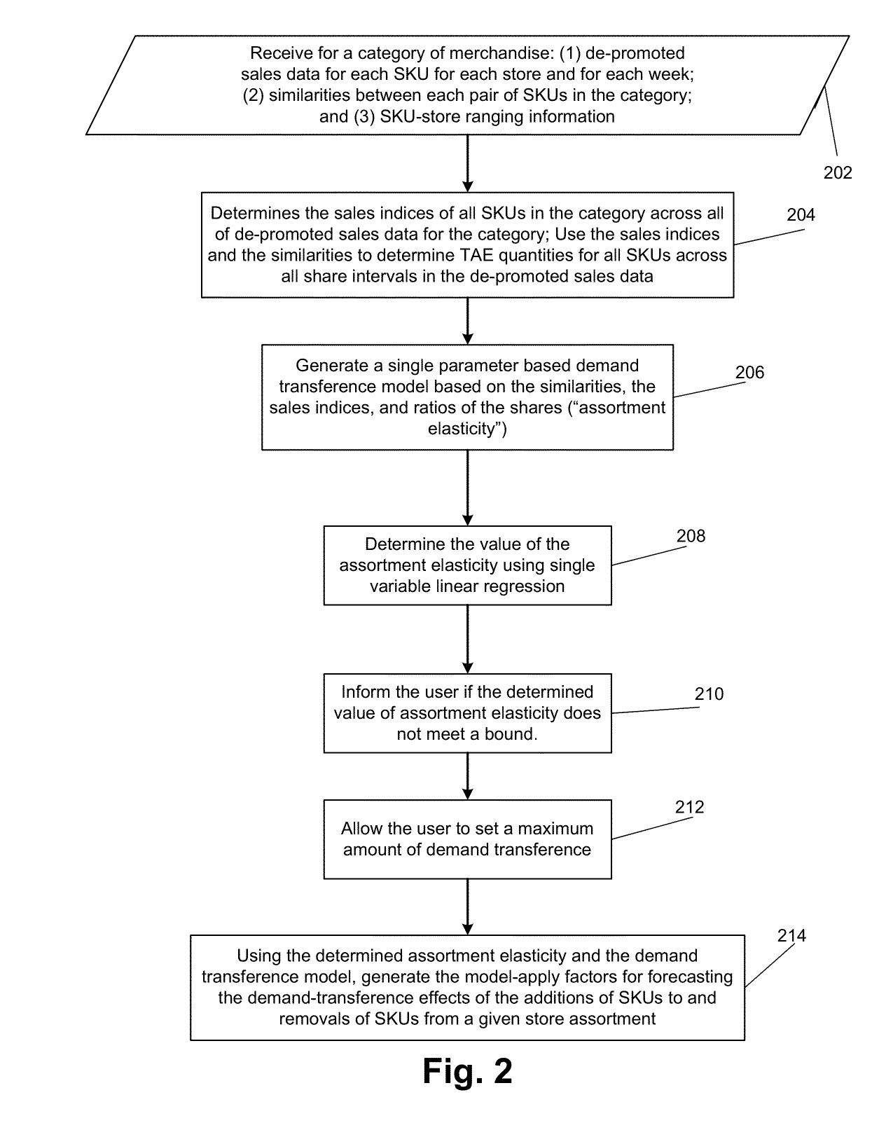

FIG. 2 is a flow diagram of the functionality of the demand transference forecast module 16 of FIG. 1 when determining a demand transference forecast in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, for a category of merchandise, module 16 receives: (1) de-promoted sales information for each SKU for each store and for each week; (2) similarities between each pair of SKUs in the category; and (3) SKU-store ranging information.

At 204, module 16 determines the sales indices of all SKUs in the category across all of de-promoted sales data for the category. The sales indices and the similarities are used to determine TAE quantities for all SKUs across all share intervals in the de-promoted sales data, as specified in Equation 1 above. SKU shares of all SKUs across all share intervals in the de-promoted sales data are calculated.

At 206, module 16 generates a single parameter based demand transference model based on the similarities, the sales indices, and ratios of the shares. The single parameter is the “assortment elasticity”, and is disclosed in Equation 2 above.

At 208, the value of the assortment elasticity using single variable linear regression is determined.

At 210, using the bound disclosed in Equation 4 above, module 16 informs the user if the determined value of assortment elasticity does not meet the bound. Module 16 further informs the user that the calculated value of assortment elasticity may generate unreasonable demand-transference results (i.e., because it does not meet the bound given in Equation 4).

At 212, using Equation 5 disclosed above, module 16 allows the user to set a maximum amount of demand transference (i.e., the value of M in Equation 5). If the calculated value of assortment elasticity does not meet the bound specified in Equation 5, then the value of the assortment elasticity is updated to the value given by the left-hand side of Equation 5. This provides the user control over the final calculated value of assortment elasticity in terms that the user can understand (i.e., the amount of demand transferred), instead of asking the user to set the desired value of assortment elasticity directly.

At 214, using the determined assortment elasticity and the demand transference model, module 16 generates the model-apply factors for forecasting the demand-transference effects of the additions of SKUs to and removals of SKUs from a given store assortment. This allows the user to perform a “what-if” analysis of assortment changes to a specific store.

### Examples of Demand Transference

As disclosed above, substitutability or item similarity is not computed in disclosed embodiments, but is provided as inputs. However, because similarity plays a role in how demand is transferred, below are a few examples of similarity.

In the “Chocolate” category at Store “X”, examples of very substitutable chocolates are the following two SKUs:

| Item | Brand | Size | Class | Type | Form | Flavor |
|---|---|---|---|---|---|---|
| 1 | AH | M | Milk | Standard | Bar | Non-Flavored |
| 2 | Cote D Or | M | Milk | Standard | Bar | Non-flavored |

“AH” is the store brand, and “Cote D Or” is a high-selling brand (not niche). As shown, these two chocolates are very generic chocolates.

Examples of very non-substitutable chocolates are:

| Item | Brand | Size | Class | Type | Form | Flavor |
|---|---|---|---|---|---|---|
| 1 | Ricar | L | White | Standard | Candy | Raisin |
| 2 | Ferrero | M | White | Kinder | Candy | Hazelnut |

These two chocolates are very unusual, being first white chocolate, and then being candies rather than the normal chocolate bars, and also having unusual flavors. These are niche products, and consumers looking for these will not consider other chocolates to be similar.

Note that although an SKU may be highly substitutable, it is not always true that a retailer will automatically want to drop the SKU from the assortment. In the example above, it is unlikely that the retailer will drop its generic milk-chocolate bars, since consumers expect any reasonable chocolate assortment to have these.

The following are some general examples to show how demand is transferred. For each category, the disclosed “current assortment” is the assortment taken from Store X data during a specific set of eight weeks at one of its largest stores (any SKU selling during those 8 weeks in the particular category).

Coffee Example.

Assume from the current assortment that the coffee SKU that is identified by the following attribute values was dropped: Ah, M, Standard, Ground, Pod, Non-Flavored, Light Roast. The current assortment for coffee contains approximately 250 total coffee SKUs. Embodiments of the present invention using the demand transference model predict the following:
48.55% of the demand of the dropped SKU would have been lost (meaning those people do not buy a replacement coffee from the remaining assortment).
The remaining demand is transferred (meaning people who do buy a replacement coffee from the remaining assortment). In fact, about 10% of its demand will be transferred to the following two SKUs, both of which are very similar to the dropped SKU
   (AH, L, Standard, Ground, Pod, Non-Flavored, Light Roast) (Customers switching on Size)
   (Douwe Egberts, M, Standard, Ground, Pod, Non-Flavored, Light Roast) (Switching on Brand).

Chocolate Example.

Suppose from the current chocolate assortment the chocolate SKU identified by the following attribute values is dropped: Cote D Or, M, Milk, Standard, Bar, Non-Flavored. The current chocolate assortment contains approximately 200 total SKUs. Embodiments of the present invention using the demand transference model predict the following:

33.84% of the demand of the dropped SKU will be lost.

Of the demand that remains, the top two SKUs it transfers to are:
(Verkade, S, Milk, Standard, Bar, Non-Flavored) (Switching on Brand and Size).
(Cote D Or, M, Milk, Truffle, Bar, Non-Flavored) (Switching on Type).

As further validation of embodiments of the present invention, the following experiment was performed for several stores: for each store, delete each SKU from the current assortment, one at a time. This means take the current assortment, delete a SKU, see where its demand goes, and how much of its demand is retained. Do this one at a time, separately, for each SKU in the assortment.

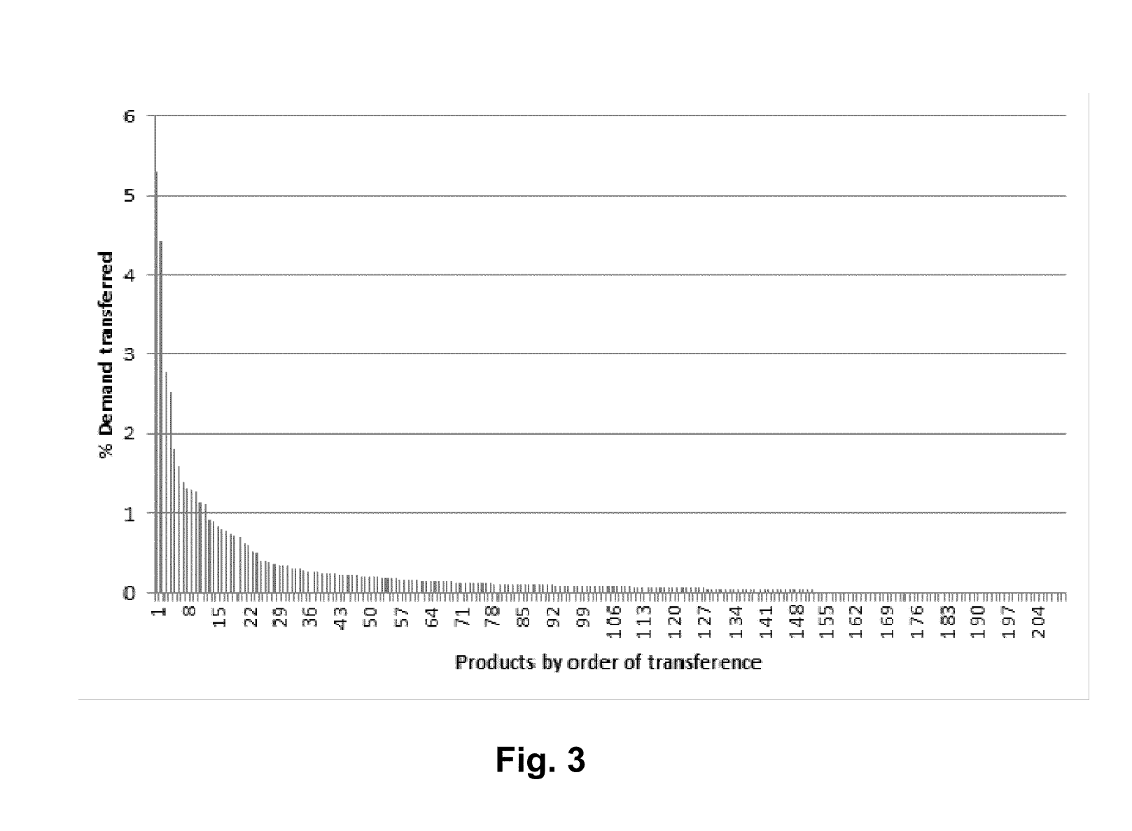

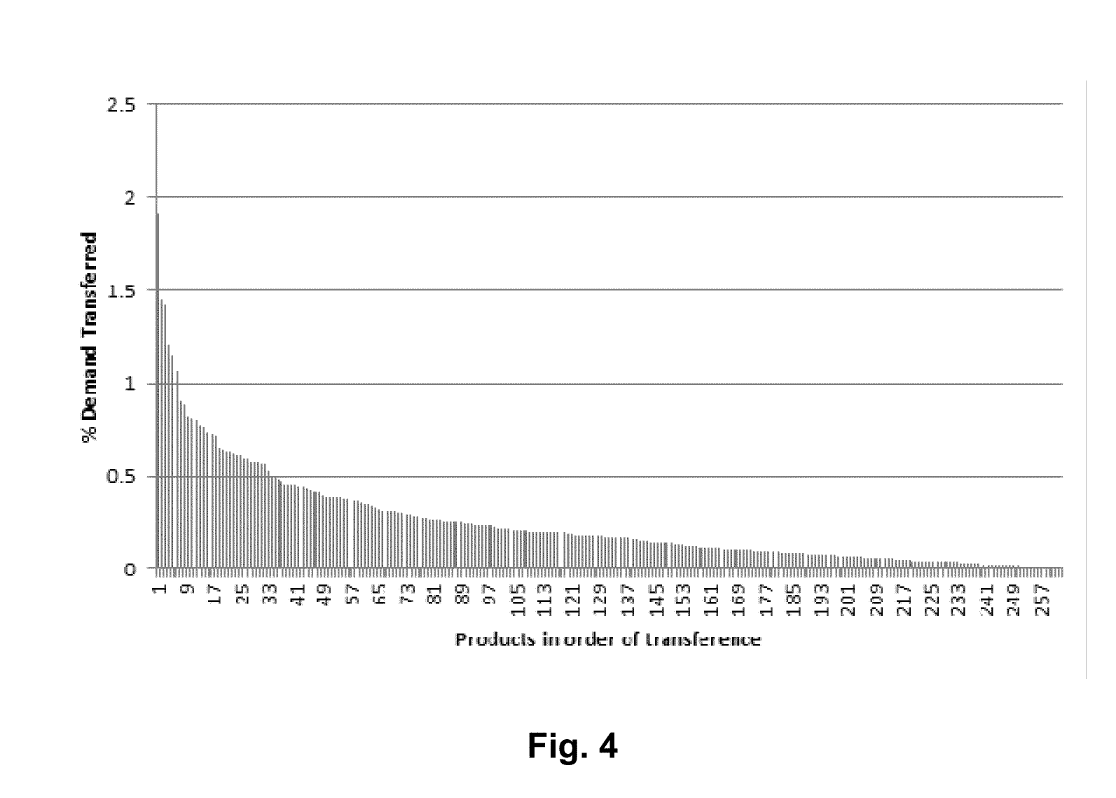

FIGS. 3 and 4 are histogram charts that show the SKUs in the current assortment ordered by decreasing amount of demand retained upon deletion. FIG. 3 is for the “Coffee” category. It shows the effects of dropping the SKU identified by the attribute values (Ah, M, Standard, Ground, Pod, Non-Flavored, Light Roast), by showing the percent of demand from the dropped SKU that is transferred to the other SKUs. Most of the demand is transferred to a few very similar SKUs.

FIG. 4 is for the “Chocolate” category. It shows the effects on the rest of the assortment of dropping the SKU identified by the attributes (Cote D Or, M, Milk, Standard, Bar, Non-Flavored). In comparison with the chart for the Coffee SKU of FIG. 3, the chocolate SKU seems to be “more transferable” in general, since the curve drops off more slowly than the one for the Coffee SKU.

Next, three curves were generated using embodiments of the present invention for three specific stores, graphing the total chocolate volume at the store as a function of the number of SKUs remaining in the assortment during random removal of SKUs from the assortment. For each store, during a single specific 4-week interval, the chocolate SKUs selling at the store during the interval were ordered in a random sequence. The SKUs were then deleted one by one in the sequence, and after each deletion, the demand-transference model in accordance with embodiments of the present invention was used to predict the total category volume. These are only partial curves, and not full curves, because they only consider removals, and not additions. However, the curves are a useful validation that the model is performing as expected in comparison to the actual real world results shown in FIG. 4.

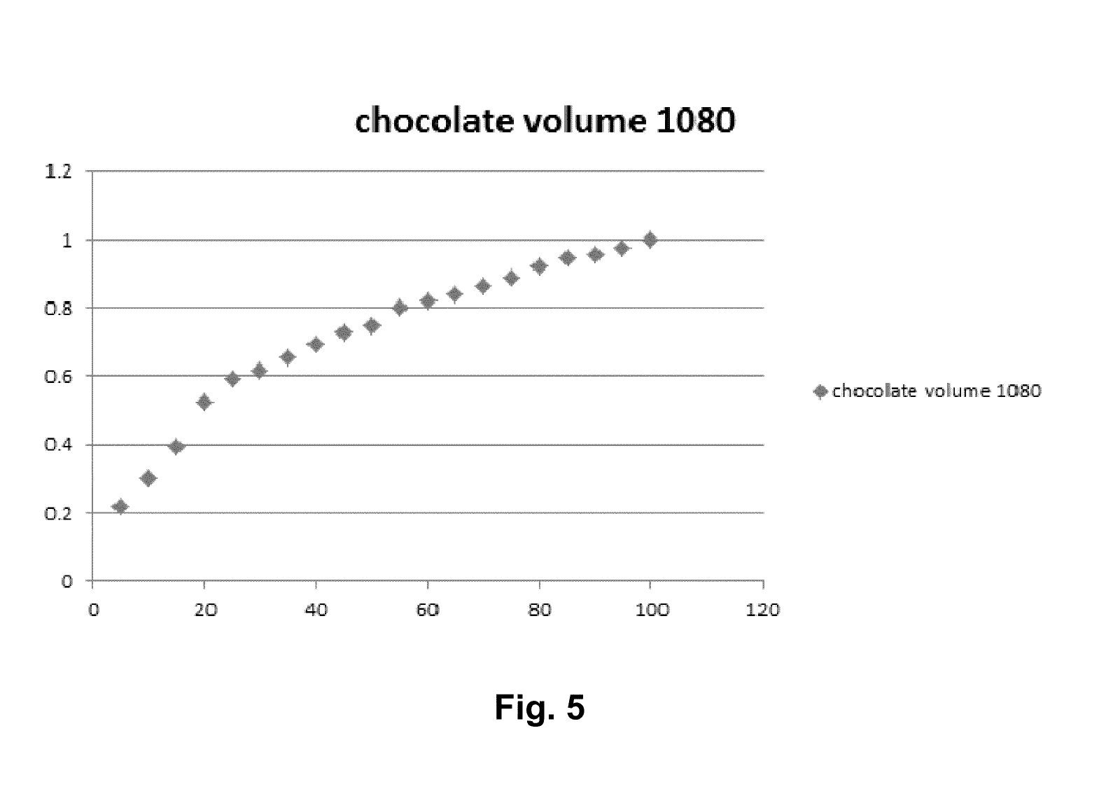

FIG. 5 illustrates a chart for store “1080”, “Chocolate” category, in accordance with embodiments of the present invention. The x-axis is the percentage of the assortment remaining after the deletions, and the y-axis is the fraction of total chocolate sales at the store, as predicted by the demand-transference model. Store 1080 is a large supermarket, stocking over 250 chocolate SKUs during the specific 4-week interval chosen for the above chart.

As shown, the incrementally curve indeed has the correct shape, being steeper for smaller x values and then flattening out as the percentage approaches 100. Because 1080 is a large store and carries many chocolate SKUs, it is expected that the flattening would be more evident.

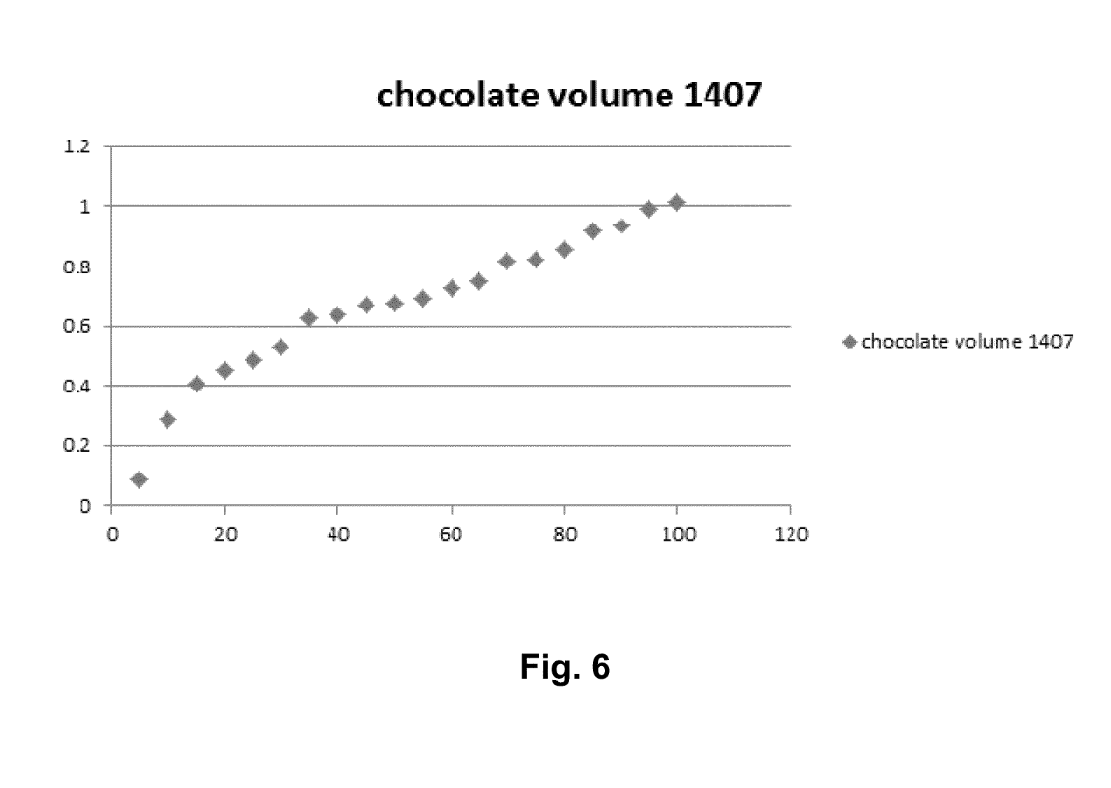

FIG. 6 illustrates a chart for store “1407”, “Chocolate” category, in accordance with embodiments of the present invention. Store 1407 is a much smaller store than store 1080, carrying only 84 chocolate SKUs. For this store, the early part of the curve is steeper than the later part, but the flattening is not as evident, because the number of SKUs is small. With the entire assortment at only 84 SKUs, it is possible to add more SKUs to the assortment and obtain further incremental store sales of chocolate.

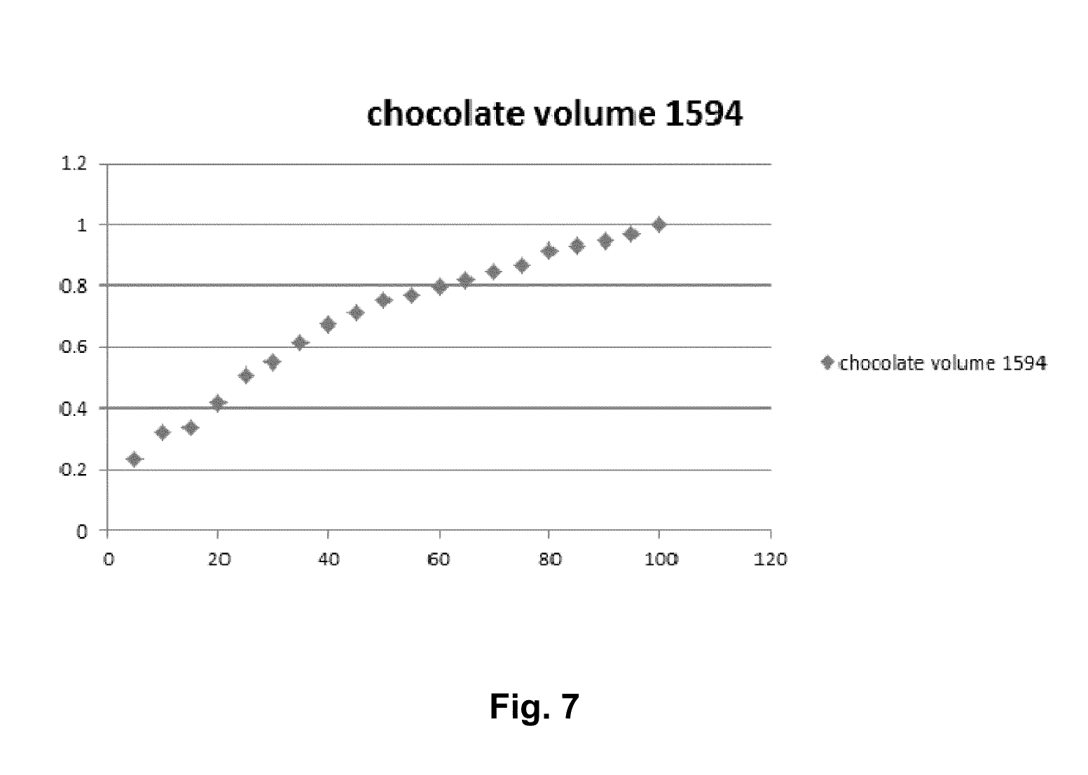

FIG. 7 illustrates a chart for store “1594”, “Chocolate” category, in accordance with embodiments of the present invention. Store 1594 a mid-sized store, with 177 chocolate SKUs. Thus, it is mid-way between the smaller store 1407 of FIG. 6 and the large supermarket 1080 of FIG. 5.

As disclosed, the model for demand transference in accordance with embodiments of the present invention is relatively simple in that it incorporates only one parameter, in contrast to prior approaches that use complex models that frequently have hundreds of parameters and also are non-linear, so that using standard regression is not a possibility. The value for the one parameter can be determined fairly easily, and the determination can even be performed within a database.

The simplicity of the model in accordance with embodiments of the present invention produces a scalable implementation, which is important because of the number of categories that large retailers typically have. Further, it is relatively easy to obtain a linear version of the model in accordance with embodiments, for use with linear programming techniques, as discussed above.

As disclosed, embodiments include the ability to forecast demand transference and is useful in products designed to help category managers make assortment decisions. In addition, demand transference is useful in products that perform sales forecasting, since these forecasts can now be modified to include effects from demand transference when assortments change.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to forecast demand transference for a category of merchandise, the forecasting comprising:
receiving for the category of merchandise de-promoted sales data for each of a plurality of stock keeping units (SKUs), similarities between each pair of SKUs in the category, and SKU-store ranging information;
determining a sales indices of all SKUs in the category across the de-promoted sales data for the category;
determining Total Assortment Effect (TAE) variable quantities for the SKUs across share intervals in the de-promoted sales data based on the sales indices and the similarities; and
generating a single parameter based demand transference model based on the similarities, the sales indices, and ratios of the share intervals.

2. The computer readable medium of claim 1, further comprising:
determining a value of the single parameter using single variable linear regression.

3. The computer readable medium of claim 2, further comprising:
informing a user when the determined value of the single parameter does not meet a bound.

4. The computer readable medium of claim 3, further comprising:
receiving from the user a maximum amount of demand transference.

5. The computer readable medium of claim 1, further comprising:
using the determined single parameter value and the demand transference model, generating model-apply factors for forecasting the demand transference effects of additions of SKUs to and removals of SKUs from a given store assortment.

6. The computer readable medium of claim 1, wherein the determining TAE comprises the variable TAE(i,s,w) for SKU i at store s in week w, comprising
$$TAE ( i , s , w ) = {\sum }_{j ∈ a ( s , w ) , j \neq i}^{ } sim ( i , j ) \cdot index ( j , s , w )$$
wherein the set a(s,w) is the set of items in the assortment of s at week w, wherein the sum is taken over all items j different from i that are in the assortment of store s at week w;
wherein the quantity sim(i,j) is the similarity of item i to item j, and the quantity index(j,s,w), is a measure of the rate of sale of j at s relative to all other SKUs selling at s.

7. The computer readable medium of claim 6, wherein the single parameter based demand transference model comprises:
$$\frac{D ( i , s , w )}{D ( i , {s}^{′} , {w}^{′} )} \sim {( \frac{1 + TAE ( i , s , w )}{1 + TAE ( i , {s}^{′} , {w}^{′} )} )}^{α}$$
wherein D(i,s,w) comprises sales-unit shares of i at s during week w, and assortment changes are across time, where week w and week w′ are two different time periods, and store s and store s′ are two different stores.

8. A method for forecasting demand transference for a category of merchandise, the method comprising:
receiving for the category of merchandise de-promoted sales data for each of a plurality of stock keeping units (SKUs), similarities between each pair of SKUs in the category, and SKU-store ranging information;
determining a sales indices of all SKUs in the category across the de-promoted sales data for the category;
determining Total Assortment Effect (TAE) variable quantities for the SKUs across share intervals in the de-promoted sales data based on the sales indices and the similarities; and
generating a single parameter based demand transference model based on the similarities, the sales indices, and ratios of the share intervals.

9. The method of claim 8, further comprising:
determining a value of the single parameter using single variable linear regression.

10. The method of claim 9, further comprising:
informing a user when the determined value of the single parameter does not meet a bound.

11. The method of claim 10, further comprising:
receiving from the user a maximum amount of demand transference.

12. The method of claim 8, further comprising:
using the determined single parameter value and the demand transference model, generating model-apply factors for forecasting the demand transference effects of additions of SKUs to and removals of SKUs from a given store assortment.

13. The method of claim 8, wherein the determining TAE comprises the variable TAE(i,s,w) for SKU i at store s in week w, comprising
$$TAE ( i , s , w ) = {\sum }_{j ∈ a ( s , w ) , j \neq i}^{ } sim ( i , j ) \cdot index ( j , s , w )$$
wherein the set a(s,w) is the set of items in the assortment of s at week w, wherein the sum is taken over all items j different from i that are in the assortment of store s at week w;
wherein the quantity sim(i,j) is the similarity of item i to item j, and the quantity index(j,s,w), is a measure of the rate of sale of j at s relative to all other SKUs selling at s.

14. The method of claim 13, wherein the single parameter based demand transference model comprises:
$$\frac{D ( i , s , w )}{D ( i , {s}^{′} , {w}^{′} )} \sim {( \frac{1 + TAE ( i , s , w )}{1 + TAE ( i , {s}^{′} , {w}^{′} )} )}^{α}$$
wherein D(i,s,w) comprises sales-unit shares of i at s during week w, and assortment changes are across time, where week w and week w′ are two different time periods, and store s and store s′ are two different stores.

15. A demand transference forecast system comprising:
a sales indices module that receives for a category of merchandise de-promoted sales data for each of a plurality of stock keeping units (SKUs), similarities between each pair of SKUs in the category, and SKU-store ranging information and determines a sales indices of all SKUs in the category across the de-promoted sales data for the category;
a Total Assortment Effect (TAE) module that determines TAE variable quantities for the SKUs across share intervals in the de-promoted sales data based on the sales indices and the similarities; and
a model generation module that generates a single parameter based demand transference model based on the similarities, the sales indices, and ratios of the share intervals.

16. The system of claim 15, further comprising:
a forecasting module that, using the determined single parameter value and the demand transference model, generates model-apply factors for forecasting the demand transference effects of additions of SKUs to and removals of SKUs from a given store assortment.

17. The system of claim 16, wherein the determining TAE comprises the variable TAE(i,s,w) for SKU i at store s in week w, comprising
$$TAE ( i , s , w ) = {\sum }_{j ∈ a ( s , w ) , j \neq i}^{ } sim ( i , j ) \cdot index ( j , s , w )$$
wherein the set a(s,w) is the set of items in the assortment of s at week w, wherein the sum is taken over all items j different from i that are in the assortment of store s at week w;
wherein the quantity sim(i,j) is the similarity of item i to item j, and the quantity index(j,s,w), is a measure of the rate of sale of j at s relative to all other SKUs selling at s.

18. The system of claim 16, wherein the single parameter based demand transference model comprises:
$$\frac{D ( i , s , w )}{D ( i , {s}^{′} , {w}^{′} )} \sim {( \frac{1 + TAE ( i , s , w )}{1 + TAE ( i , {s}^{′} , {w}^{′} )} )}^{α}$$
wherein D(i,s,w) comprises sales-unit shares of i at s during week w, and assortment changes are across time, where week w and week w′ are two different time periods, and store s and store s′ are two different stores.

19. The system of claim 15, further comprising:
determining a value of the single parameter using single variable linear regression.

20. The system of claim 19, further comprising:
receiving from the user a maximum amount of demand transference.
